(19) United States
(12) Patent Application Publication
(10) Pub. No.: US 2012/0066205 A1
(43) Pub. Date: Mar. 15, 2012

(54) Query Compilation Optimization System and Method

(75) Inventors: Geoffrey Chappell, Belfast, ME (US); Derrish Repchick, Putney, VT (US)

(73) Assignee: INTELLIDIMENSION, INC., Brattleboro, VT (US)

(21) Appl. No.: 13/047,347

(22) Filed: Mar. 14, 2011

Related U.S. Application Data
(60) Provisional application No. 61/313,791, filed on Mar. 14, 2010.

(51) Int. Cl. G06F 17/30

(52) U.S. Cl. 707/713; 707/E17.131

(57) ABSTRACT

A system and method of compiling a query involving clumping contiguous constraints of a query into one or more subqueries based on partition organization parameters and evaluating each subquery against a partition of a graph having data records for the corresponding partition organization parameter value. In one example, clumping of contiguous query constraints based on an RDF data component, such as a subject, may be used to evaluating subqueries of a query against one or more partitions of a graph having RDF data records with that subject.

### RELATED APPLICATION DATA

This application claims the benefit of priority of U.S. Provisional Patent Application Ser. No. 61/313,791, filed Mar. 14, 2010, and titled “Query Compilation Optimization System and Method,” which is incorporated by reference herein in its entirety.

### FIELD OF THE INVENTION

The present invention generally relates to the field of data management query compilation. In particular, the present invention is directed to a query compilation optimization system and method.

### SUMMARY OF THE DISCLOSURE

In one exemplary implementation, a method of optimizing query compilation is provided. The method includes receiving one or more constraints of a query; identifying contiguous constraints having the same partition organization parameter value; clumping the contiguous constraints by partition organization parameter; organizing each clumping of constraints into a subquery; compiling each subquery; and evaluating each subquery against a partition of a graph, the partition having data records for the corresponding partition organization parameter value.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates an exemplary implementation of a data query system;

FIG. 2 illustrates an exemplary implementation of a method of optimizing a query for evaluation against partitioned data;

FIG. 3 illustrates an exemplary implementation of a data management system;

FIG. 4 illustrates another exemplary implementation of a data management system;

FIG. 5 illustrates another exemplary implementation of a method of query optimization; and

FIG. 6 illustrates a diagrammatic representation of one implementation of a computing device.

### DESCRIPTION

A query compilation optimization system and method are provided. In one exemplary aspect, data is stored in partitions based on a partition organization parameter, such that all data records having a given value of a partition organization parameter are stored in the same partition. A partition organization parameter is a parameter of a data record that can be used to organize the data records into two or more partitions. Example partition organization parameters include, but are not limited to, a subject of a resource description framework statement, a predicate of a resource description framework statement, an object of a resource description framework statement, a context of a resource description framework statement, a field of a relational database record, and any combinations thereof. Resource description framework subjects, objects, predicates, and contexts are discussed in detail below.

A partition organization parameter can be utilized to represent an entity in the data. An entity is something described in the data that exists and/or can be perceived as a single separate object. For example, an entity in a resource description framework format may be represented by one or more resource description framework statements that have the same subject value.

A query can include a number of constraints. In one embodiment, a query optimization can include clumping contiguous constraints having the same value for a partition organization parameter into a subquery that can be evaluated against a single partition of a data management system.

Various formats for a data record are known. Data record formats include, but are not limited to, a relational database format, a resource description framework format, other formats. In one example, a data record is in a resource description framework format. A data record is a group of related data values.

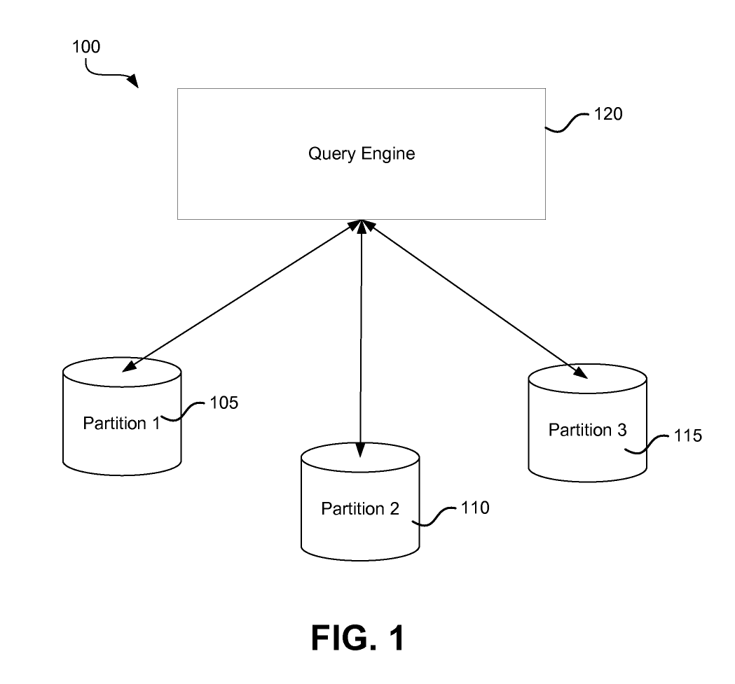

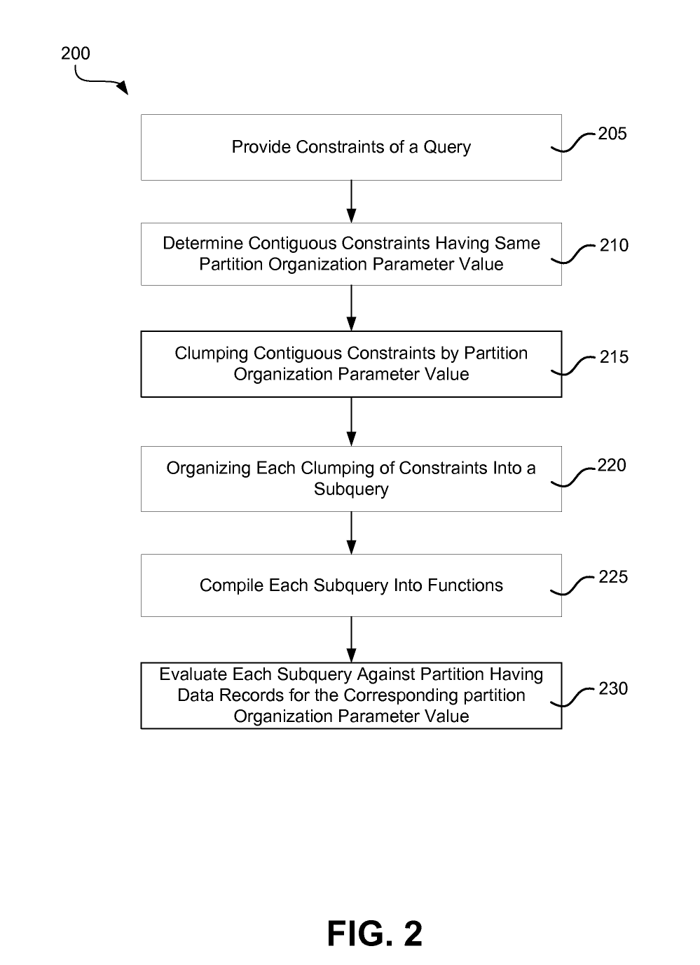

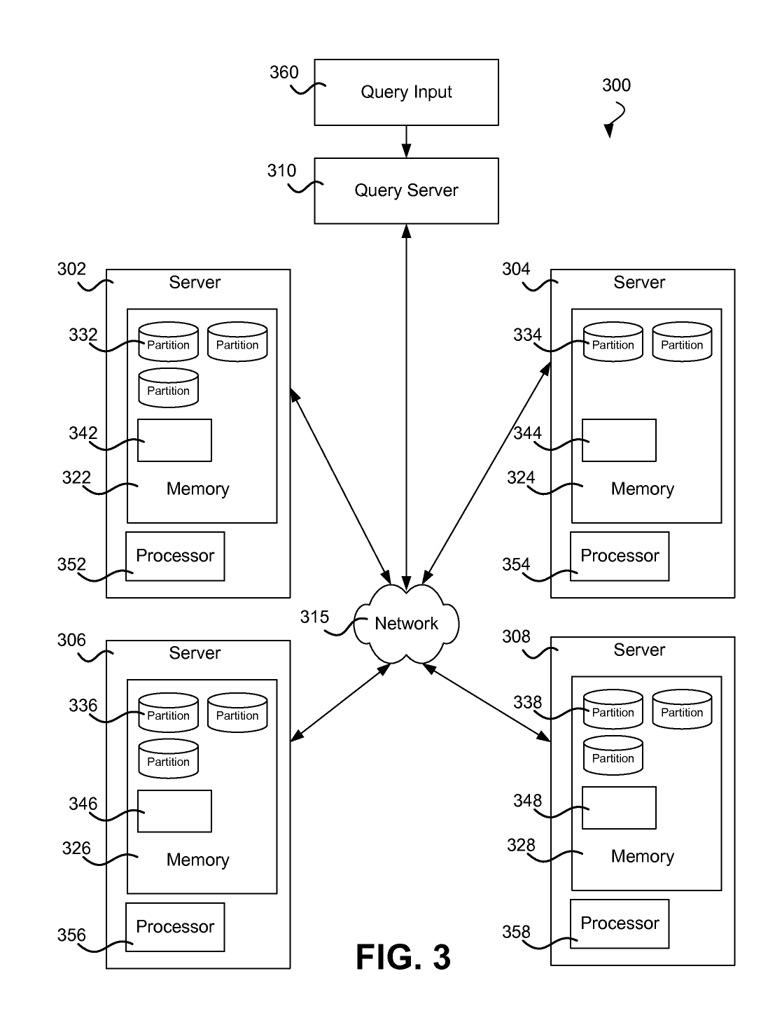

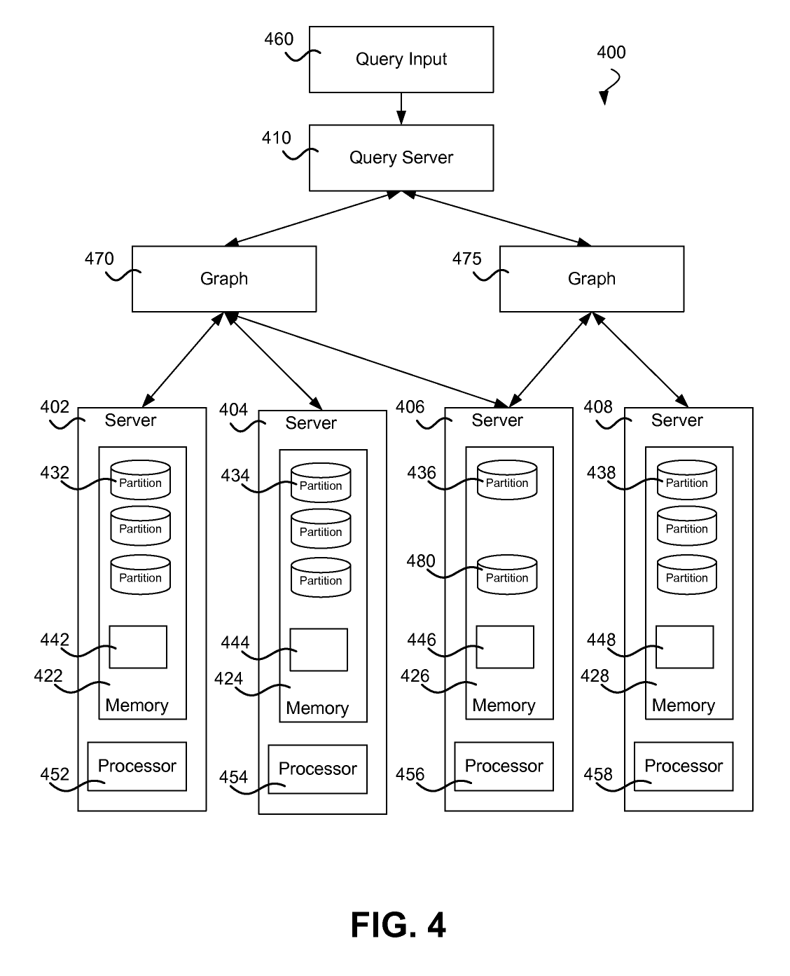

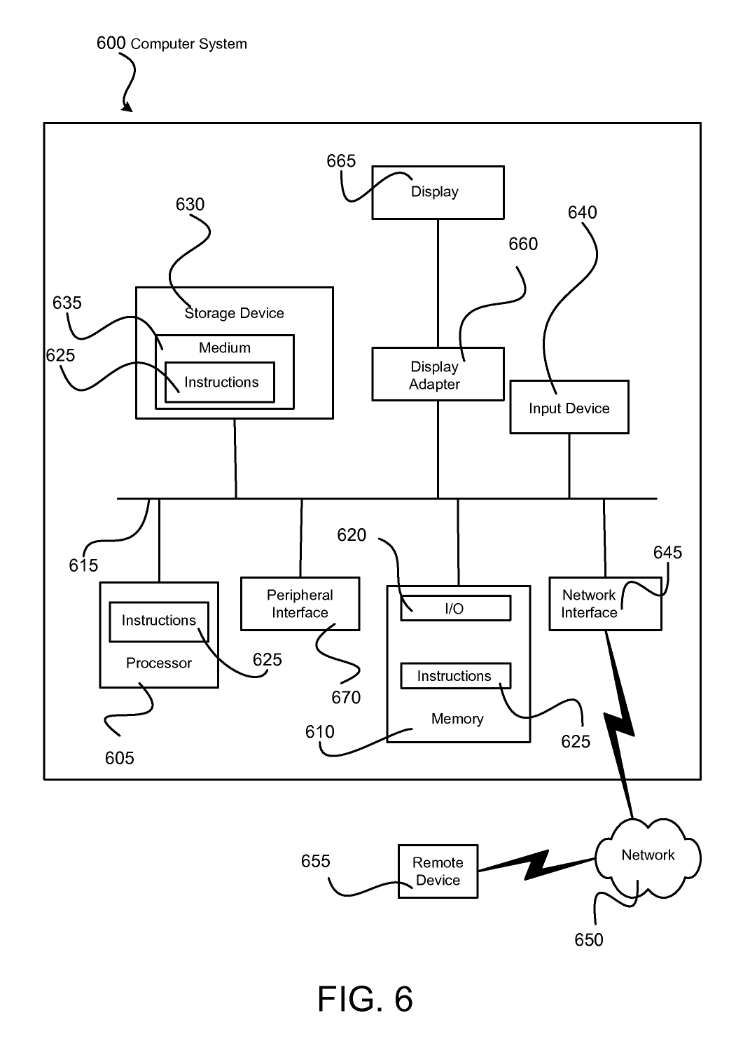

FIG. 1 illustrates an exemplary implementation of a data query system 100 in which data is stored in three partitions 105, 110, and 115. Data records having the same value for a partition organization parameter are stored in one of partitions 105, 110, and 115. Although three partitions are shown in this example, any number of partitions can be utilized. It is possible that each of partitions 105, 110, and 115 may include two or more sets of data records, each set having the same value for a partition organization parameter. System 100 includes a query engine 120 configured to receive a query, track which data is in each of partitions 105, 110, 115; compile the query for evaluation against the data in partitions 105, 110, 115; and apply the compiled query to the data. The compilation of the query includes clumping contiguous constraints having the same value for a partition organization parameter into an executable subquery. More details of an example of such a compilation are discussed below with respect to FIG. 2. In one example, query engine 120 may include processing and other hardware configured with executable instructions for performing its tasks. An exemplary machine for executing one or more of the aspects of system 100 is discussed further below with respect to FIG. 6. Any one or more of the aspect of system 100 may be associated with one or more computing resources. In one example, query engine 120 and partitions 105, 110, 115 are associated with one computing device, such as a database server. In another example, partition 105, partition 110, partition 115, and one or more of the aspects of query engine 120 are distributed across two or more computing devices (e.g., computers connected via one or more networks). Two such examples of a distributed data management system is described below with respect to FIGS. 3 and 4.

As discussed above, one way to organize data is in a Resource Description Framework. Resource Description Framework, commonly referred to as RDF, is a family of World Wide Web Consortium specifications. RDF utilizes resource description framework statements to represent resources in a data model. Examples of resources that can be represented in an RDF data model include, but are not limited to, resources from the World Wide Web, resources from one or more databases, and any combinations thereof. An RDF statement typically includes a subject, a predicate, and an object. A subject identifies a particular resource. An object identifies something about a subject. A predicate identifies a relationship between the subject and the object. An RDF statement may include additional information other than a subject, predicate, and object. Typically, an RDF statement is referred to as a “triple.” It is possible that an additional data element, such as the context and/or source of the RDF statement, also be included for each RDF statement. In one such example, an RDF statement may be referred to as a “quad” or “quadruple.” Other variations of an RDF statement are contemplated.

Data values for the subject, predicate, and object of an RDF statement may take a variety of general forms. Examples of such forms include, but are not limited to, a Uniform Resource Identifier (“URI”), a literal data value, a blank value, and any combinations thereof. In one example, the subject, predicate, and object of an RDF statement each utilize the same form of data value. In another example, each of the subject, predicate, and object of an RDF statement utilize any one of the example data forms discussed above. The subject of an RDF statement is typically in the form of a Uniform Resource Identifier (“URI”). Other forms are also possible, such as a blank node or a literal. A URI can represent any resource. In one aspect, a URI may be represented as an addressable location of a resource on a network. Examples of networks for which a URI may represent a resource include, but are not limited to, the Internet (e.g., the World Wide Web), a local area network, a wide area network, a directly connected database, and any combinations thereof. In one such example, a URI may take the form of an identifier beginning with the “http:” prefix. A URI may also utilize the “http:” prefix (or similar variant, such as “shttp:”) where the URI does not actually represent a location of a network accessible resource. The predicate and/or object of an RDF statement may also be represented as a URI. Literal data statements may also be used for one or more of a subject, predicate, and object of an RDF statement. In one example, an object of an RDF statement is a literal data statement.

An RDF statement and its data values may be encoded in any of a variety of serialization or file formats. Examples of serialization formats for an RDF statement include, but are not limited to, an XML format, a Notation 3 (“N3”) format, a Turtle format, an N-Triples format, and any combinations thereof. A serialization format may utilize a known set of URI's to identify aspects of a subject, predicate, and/or object. In another example, a serialization format may utilize a proprietary notation format.

An original RDF statement that represents a resource itself may have additional RDF statements that refer back to the original RDF statement as being its own resource. In one such example, the original RDF statement may be assigned a URI to which other RDF statements may refer. Examples of additional RDF statements that may be made referring to an original RDF statement include, but are not limited to, an RDF statement referring to the original RDF statement's subject as a resource, an RDF statement referring to the original RDF statement's predicate as a resource, an RDF statement referring to the original RDF statement's object as a resource, and any combinations thereof.

Table 1 illustrates an example set of RDF statements. The first seven RDF statements in the table include URI data value's for the subject and predicate and a literal data value for the object. The remaining RDF statements in the table include URI data values for each of the subject, predicate, and object.

TABLE 1
Example RDF Statements
RDF Statements (Input Data)

| Subject (s) | Predicate (P) | Object (O) |
|---|---|---|
| <http://uspres.x/gwashington> | <http://ontology.z/FirstName> | “George” |
| <http://uspres.x/gwashington> | <http://ontology.z/LastName> | “Washington” |
| <http://presinfo.x/geowash> | <http://ontology.z/FirstName> | “George” |
| <http://presinfo.x/geowash> | <http://ontology.z/LastName> | “Washington” |
| <http://presinfo.x/geowash> | <http://ontology.z/BirthState> | “Virginia” |
| <http://presinfo.x/geowash> | <http://ontology.z/VicePresident> | “John Adams” |
| <http://history- | <http://ontology.z/Name> | “George Washington” |
| usa.x/george_washington> | | |
| <http://usnews.x/article/2009/09/01> | <http://ontology.a/President> | <http://uspres.x/gwashington> |
| <http://encyclopedia.x/vol1/uspresidents> | <http://ontology.b/FirstPresident> | <http://uspres.x/gwashington> |
| <http://whitehouse.x/presidents> | <http://ontology.c/USPresident> | <http://uspres.x/gwashington> |
| <http://johndoe.x/blog/2009/06/15> | <http://ontology.d/Person> | <http://presinfo.x/geowash> |
| <http://uscurrency.x/onedollarbill/> | <http://ontology.e/PortraitOf> | <http://presinfo.x/geowash> |
| <http://usrevolution.x/> | <http://ontology.f/General> | <http://history- |
| | | usa.x/george_washington> |

In this limited example set of RDF statements, as shown in Table 1, two RDF statements have a subject value of <http://uspres.x/gwashington>, five RDF statements have a subject value of <http://presinfo.x/geowash>, and the remaining RDF statements have different subject values. Referring again to FIG. 1, in one example partitioning of these RDF statements, statements having a subject value of <http://uspres.x/gwashington> are located in partition 105 along with statements having subject values <http://history-usa.x/george_washington> and <http://usnews.x/article/2009/09/01>; statements having a subject value of <http://presinfo.x/geowash> are located in partition 110; and statements having a subject values of <http://encyclopedia.x/vol1/uspresidents>, <http://whitehouse.x/presidents>, <http://johndoe.x/blog/2009/06/15>, <http://uscurrency.x/onedollarbill/>, and <http://usrevolution.x/> are located in partition 115.

It is possible to assign a handle value to a data values. It should be noted that handle values do not need to be assigned to all data values in a group of RDF statements. A handle value is a value that replaces the original data value with another statement that is usually smaller in data size. Using handle values to store RDF statements can minimize the computing resources required to manage the RDF statements and/or increase the speed of retrieval of information from the RDF statements. This may be particularly significant decrease in resources required when the number of RDF statements is very large and/or the repetition of particular data values across the RDF statement is large.

A relationship between each data value and the assigned handle value can be maintained in a library. Example ways to maintain the relationship between the data value and the handle value include, but are not limited to, a cross-over table, other relationship monitoring format in a memory, and any combinations thereof.

Table 2 illustrates an example assignment of handle values for data values of the RDF statements in Table 1. In this example, numerical handle values 1 to 17 are assigned to the data values. Here, the data values from the subjects, predicates, and objects of the RDF statements in Table 1 are assigned handle values. In this example, some of the data values are not assigned handles. In other examples, all of the data values can be assigned handles.

TABLE 2
Example Handle Assignment
Handle Table

| Handle | |
|---|---|
| ID | Value |
| 1 | <http://uspres.x/gwashington> |
| 2 | <http://presinfo.x/geowash> |
| 3 | <http://history-usa.x/george_washington> |
| 4 | <http://encyclopedia.x/vol1/uspresidents> |
| 5 | <http://johndoe.x/blog/2009/06/15> |
| 6 | <http://uscurrency.x/onedollarbill/> |
| 7 | <http://usnews.x/article/2009/09/01> |
| 8 | <http://usrevolution.x/> |
| 9 | <http://whitehouse.x/presidents> |
| 10 | <http://ontology.z/Name> |
| 11 | “George Washington” |
| 12 | <http://ontology.a/President> |
| 13 | <http://ontology.b/FirstPresident> |
| 14 | <http://ontology.c/USPresident> |
| 15 | <http://ontology.d/Person> |
| 16 | <http://ontology.e/PortraitOf> |
| 17 | <http://ontology.f/General> |

FIG. 2 illustrates one implementation of a method 200 of optimizing a query for evaluation against partitioned data. At step 205, constraints of a query are provided. Queries to a set of data can come in a variety of formats. Example formats include, but are not limited to, SPARQL, DQL, N3QL, R-Device, RDFQ, RDQ, RDQL, RQL/RVL, SeRQL, Versa, XUL, Adenine, SQL (“Structured Query Language”), OQL (“Object Query Language”), CQL (“Common Query Language”), YQL (“Yahoo! Query Language”), DMX (“Data Mining Extensions”), and any combinations thereof. In one example of an RDF data system, a SPARQL query can be utilized.

Step 205 may include converting a provided query into an abstract form. In another example, a query may be provided (e.g., provided to a query engine and/or query server) in an abstract form. Examples of abstract forms of a query include, but are not limited to, sum of products (“SOP”) form. In one example, an SOP form represents a logical expression in which a logical “OR” operator is applied to two or more subexpressions, each of which is an application of a logical AND operator.

Step 205 may also include ordering the constraints of the query (e.g., the query in abstract form) for efficient application to the specific organization of the data and the data itself. In one example, the ordering may be done based on statistics of the database. A variety of ways to order constraints of a query for efficient application to specific data will be clear to those of ordinary skill in light of this disclosure. One such example of ordering utilizes cost-based ordering.

For illustrative purposes, an example SPARQL query in an RDF environment will be considered. In this example, the RDF data is partitioned based on the subject of the RDF statements. An example query of finding all companies that have an employee named John Doe can be written as follows:

```
select ?c where {
  ?c rdf:type x:Company.
  ?c x:employee ?e.
  ?e x:firstName “John”.
  ?e x:lastName “Doe”.
}
```

This example query is shown in a representative SPARQL notation. It should be noted that RDF systems and associated queries can utilize any of a variety of notations. This notation is used as an example.

An abstract representation of this exemplary query can be written in SOP form as:

answer(?c):
statement(?c rdf:type x:Company),
statement(?c x:employee ?e),
statement(?e x:firstName “John”),
statement(?e x:lastName “Doe”)

This example abstract representation of the query includes four constraints: statement(?c rdf:type x:Company), statement(?c x:employee ?e), statement(?e x:firstName “John”), and statement(?e x:lastName “Doe”). The first two constraints include the unbound variable “?c”, representing a subject value. The third and fourth constraints include the variable “?e”, representing a subject value.

At step 210, contiguous constraints in the query are determined that have the same value for the partition organization parameter. Contiguous constraints are constraints that are next to each other in the query order. In the example from above, the partition organization parameter is subject. The first two constraints are directed to the same subject, represented by “?c”, and are contiguous. The third and fourth constraints are directed to the same subject, represented by “?e”, and are contiguous. This example includes all constraints to the same subject value being ordered together. It is possible that constraints to the same subject may be ordered such that all of the constraints to that subject are not contiguous with each other.

At step 215, contiguous constraints that have the same value for the partition organization parameter are clumped. In the example from above, two clumpings occur:

Clumping 1: statement(?c rdf:type x:Company) and statement(?c x:employee ?e); and

Clumping 2: statement(?e x:firstName “John”) and statement(?e x:lastName “Doe”)

At step 220, each clumping is organized into a subquery. The results of each sub-query can be joined together to produce the desired result to the query. In the example from above, the query is clumped into subqueries as follows:

answer (?c) :
subquery(?c, ?e):
statement(?c rdf:type x:Company),
statement(?c x:employee ?e)
subquery(?e):
statement(?e x:firstName “John”),
statement(?e x:lastName “Doe”)

where subquery(?c, ?e) represents the first clumping and subquery (?e) represents the second clumping, the results of each being joined to give the answer (?c).

At step 225, each subquery is further compiled such that each subquery can be executed against the data format being used to store the data in the partitions. Those of ordinary skill will recognize a variety of ways to formulate the executable functions for the subqueries produced at step 220. This compiling may include converting the constraints to executable functions in a form compatible with the data format being used. Example aspects to consider in compiling a query include, but are not limited to, ordering operations, maximizing ability to run operations in parallel, consideration of the statistics of the data in the target data graph, and any combinations thereof. The compilation may include ordering operations of the query into an order that will be compatible with the data graph and other data used to resolve the query. For example, the operations may be ordered to have operations that will produce intermediate tables needed in a later operation perform before the later operations. By looking at the data that will be required in later operations, it may be possible to reduce the number of joins in the query. In another example, a query can be compiled with a consideration for maximizing the ability for operations to run in parallel (e.g., via partitioning scheme design, etc.). Additionally, statistics of the data may be utilized to structure and organize operations for efficient evaluation of the data. Example query compilers are commercially available. One example of a commercially available query compiler is Semantics.Server available from Intellidimension, Inc. of Brattleboro, Vt.

At step 230, each subquery is evaluated against data within the partition having the data records corresponding to the partition organization parameter value for that subquery. Those of ordinary skill will recognize a variety of ways to evaluate the executable functions of a subquery against data in a partition. Results from each subquery may be joined to answer the query.

FIG. 3 illustrates an exemplary implementation of a data management system 300. System 300 includes servers 302, 304, 306, 308 interconnected with a query server 310 via one or more networks 315. Exemplary networks are discussed below with respect to FIG. 6. Each of servers 302, 304, 306, 308 includes memory elements 322, 324, 326, 328, respectively, for storing data of the data management system 300. Each of memory elements 322, 324, 326, 328 may include one or more physical memory elements. Example memory elements (e.g., computer readable storage media) capable of retaining data and/or instructions for execution are discussed below with respect to FIG. 6. Data records are partitioned into data partitions 332, 334, 336, 338 across servers 302, 304, 306, 308, respectively. Each server includes one or more partitions (e.g., server 302 includes three partitions 332 and server 304 includes two partitions 334). In one exemplary aspect, data records having the same value for a partition organizing parameter are included in the same partition. In one example, RDF statements are organized such that RDF statements having the same subject value are partitioned to the same partition. In another example RDF environment, RDF statements could be partitioned based on predicate, object, context value, subject, or any combinations thereof. As discussed above, it is contemplated that a given partition may include data records with more than one value for a partition organizing parameter.

Servers 302, 304, 306, 308 also include executable instructions 342, 344, 346, 348, respectively. Executable instructions 342, 344, 346, 348 are located in memory elements, 322, 324, 326, 328, respectively. Servers 302, 304, 306, 308 also include processing elements 352, 354, 356, 358, respectively. Each of processing elements 352, 354, 356, 358 may include one or more processing elements.

Query server 310 includes a query input 360 for inputting a query to query server 310. Example query inputs include, but are not limited to, a user input (e.g., an input device, such as exemplary input devices discussed below with respect to FIG. 6), a connection to a computing device that provides a query, and any combinations thereof. Query server 310 is also configured with other appropriate hardware (e.g., one or more processing elements, one or more memory elements, other circuitry) and executable instructions to receive a query from query input 360, convert a query to an abstract form, order constraints of a query for efficiency, determine contiguous constraints having the same value of a partition organizing parameter, generating a subquery from constraints of query for each value of a partition organizing parameter in the constraints, managing the location of data records in partitions 332, 334, 336, 338, compiling executable functions for the subqueries, delegating a query and/or subquery to a different level of the data system distribution hierarchy, evaluating a query and/or subquery against data in one or more of partitions, and any combinations thereof. Query server 310 may also include one or more tables or other record (e.g., stored in one or more memory elements) for recording the location of data records in partitions based on partition organizing parameter values (e.g., a cross-over table correlating partition location and partition organizing parameter value), for recording statistics about the data, and any combinations thereof.

In one example, data in system 300 is organized in an RDF environment with RDF statements distributed across partitions 332, 334, 336, 338 based on subject values of the RDF statements such that all RDF statements with the same subject value are in the same partition. In this example, a query is received by query server 310 in a SPARQL format. In this example, query server 310 utilizes processing resources of query server 310 and instructions stored in one or more memories to convert the query to an SOP format, order the constraints of the query for efficiency based on a cost-based ordering (e.g., utilizing a table stored in a memory of statistics regarding the data of the system), clump constraints to form subqueries as described herein, and generate executable forms of the constraints/subqueries in a format that is compatible with evaluation of the RDF environment. In this example, each subquery is then pushed down to the server having the partition storing the RDF statements with the subject value corresponding to the subquery. In this example, the subquery is then evaluated using the one or more processors 352, 354, 356, 358 of the corresponding server, the results of the each subquery are communicated to the query server 310, and the results are joined by query server 310 to provide an answer to the query. Query server 310 may include an output device for outputting the results of the query.

FIG. 4 illustrates another exemplary implementation of a data management system 400. Data management system 400 includes data servers 402, 404, 406, 408; a query server 410 (e.g., connected with servers 402, 404, 406, 408 via one or more networks); memory elements 422, 424, 426, 428; partitions 432, 434, 436, 438; executable instruction 442, 444, 446, 448; processing elements 452, 454, 456, 458; and a query input 460, each being configured and operating similarly to corresponding components of system 300 (except as described below). It may be desirable to submit a query across multiple data graphs. In this example, the data is arranged in two separate data graphs 470 and 475. Other examples having any number of data graphs are contemplated. System 400 organizes the two data graphs 470 and 475 as a virtual layer in the distribution between query server 410 and servers 402, 404, 406, 408. The virtual layer may be resident as part of query server 410 and query server 410 may include instructions and data for managing the plurality of data graphs. Data records corresponding to graph 470 are stored in partitions of servers 402, 404, and 406. Data records corresponding to graph 475 are stored in partitions of servers 406 and 408. FIG. 4 shows server 406 including a second numbered partition 480. In this exemplary implementation, data records for graph 470 are stored in one or more partitions 436 and data records for graph 475 are stored in one or more partitions 480.

In one such example, data recording Internet communications may be stored in RDF format in a system, such as system 400. In this example, data from each day is stored in a separate data graph (e.g., and each graph maintained on a rolling ten-day basis) and partitioned based on subject value and stored across multiple servers. In one example, subqueries (e.g., as described above with respect to method 200) can be pushed down to separate graph partitions separately and results joined (e.g., at the data server level and/or at the query server level).

In another exemplary implementation, one or more virtual layers may be included for other reasons. In one example, one or more virtual layers may be included in a system, such as system 400, to structure the query process to correspond to a network topology. For example, servers located on one switch can be virtually grouped together and servers located on a second switch virtually grouped together. Evaluation of queries and joins of results can occur at one or more of a variety of levels in the virtual and physical arrangement of the query system using subqueries generated as described herein based on contiguous constraints having the same value of partition organizing parameter

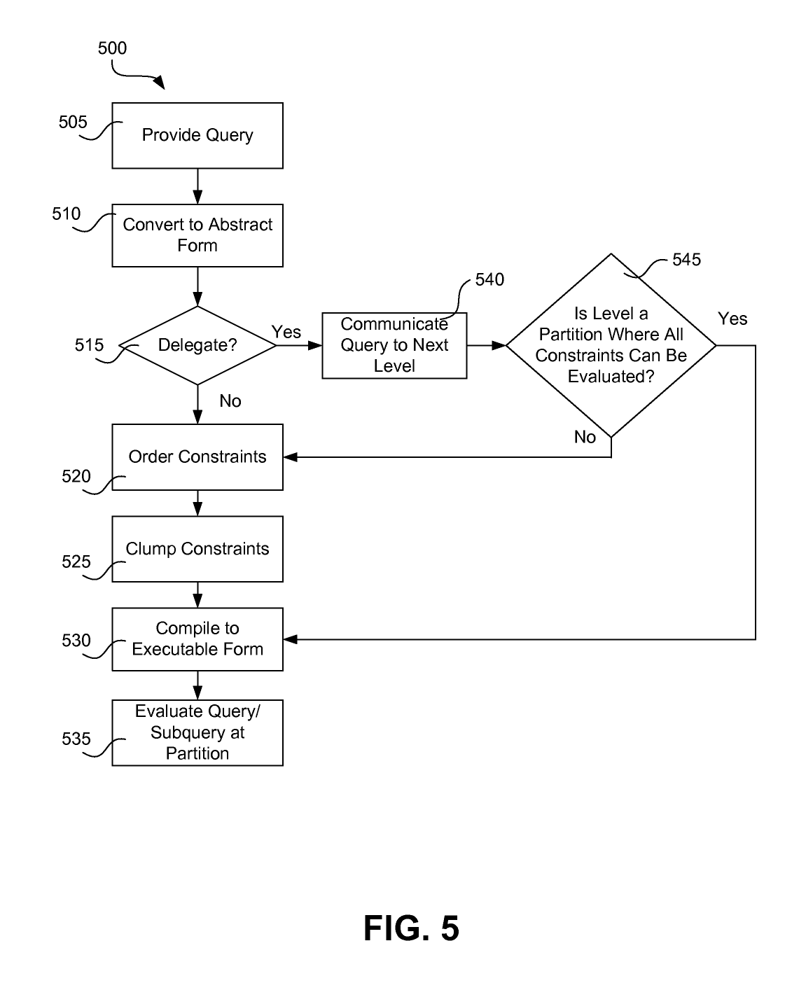

FIG. 5 illustrates another exemplary implementation of a method 500 of query optimization. In this implementation data is stored in a physically and/or virtually distributed topology. At step 505, a query is provided. At step 510, the query is converted to an abstract form. At step 515, a determination is made whether all constraints of the query can be evaluated completely at a single lower level of the distributed topology. For example, a query may include only constraints that can be evaluated against partitions in a virtual division of the data management system. In another example, a query may include only constraints that can be evaluated against a single partition. In yet another example, a query may include only constraints that can be evaluated against partitions of a single data server. If the determination is no, the process continues to step 520. If the determination is yes and delegation of the query is appropriate, the process continues to step 540.

At step 520, the constraints of the abstract form query are ordered. At step 525, the constraints are clumped to form subqueries based on contiguous constraints in the ordering that have the same value of a partition organization parameter. At step 530, the constraints of each subquery are put into a compatible executable form corresponding to the data structure and storage system of the data records to be evaluated. At step 535, each subquery is evaluated against data records in the corresponding partition. In one example, step 535 includes communicating each subquery to a data server processing resource having the corresponding partition. Results from each subquery can be joined with others to provide an answer to the query. In one example, joining may occur at the query server level, the data server level, and/or one or more virtual layers.

At step 540, the query is communicated to the next lower level in the distribution topology. At step 545, a determination is made by a processing resource at that level if the level is associated with a partition at which all of the constraints of the query can be evaluated. If yes, the process proceeds to step 530. If no, the process proceeds to step 520. The delegation step 515 in this example occurs after converting the query to abstract form and before ordering the constraints. It is contemplated that a determination of the appropriateness of delegation could occur at other locations in process 500. It is also contemplated that in a multi-level topology, steps 515, 540, and 545 could be iterated until the determination at step 545 is affirmative.

It is to be noted that the aspects and embodiments described herein may be conveniently implemented using one or more machines (e.g., one or more computing devices that are part of a query compilation optimization system) including hardware and special programming according to the teachings of the present specification, as will be apparent to those of ordinary skill in the computer art. Appropriate software coding can readily be prepared by skilled programmers based on the teachings of the present disclosure, as will be apparent to those of ordinary skill in the software art.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., tablet computer, a personal digital assistant “PDA”, a mobile telephone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

FIG. 6 shows a diagrammatic representation of one embodiment of a computing device in the exemplary form of a computer system 600 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. Computer system 600 includes a processor 605 and a memory 610 that communicate with each other, and with other components, via a bus 615. Processor 605 may include any number of processing cores. A processing resource may include any number of processors and/or processing cores to provide a processing ability to one or more of the aspects and/or methodologies described herein. Bus 615 may include any of several types of bus structures including, but not limited to, a memory bus, a memory controller, a peripheral bus, a local bus, and any combinations thereof, using any of a variety of bus architectures.

Computer 600 may include any number of memory elements, such as memory 610 and/or storage device 630 discussed below.

Memory 610 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof.

Computer system 600 may also include a storage device 630. Examples of a storage device (e.g, storage device 630) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 may be removably interfaced with computer system 600 (e.g., via an external port connector (not shown)). Particularly, storage device 630 and an associated machine-readable medium 635 may provide nonvolatile and/or volatile storage of machine-readable instructions, data structures, program modules, and/or other data for computer system 600. In one example, software 625 may reside, completely or partially, within machine-readable medium 635. In another example, software 625 may reside, completely or partially, within processor 605.

Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof.

A user may also input commands and/or other information to computer system 600 via storage device 630 (e.g., a removable disk drive, a flash drive, etc.) and/or a network interface device 645. A network interface device, such as network interface device 645 may be utilized for connecting computer system 600 to one or more of a variety of networks, such as network 650, and one or more remote devices 655 connected thereto. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a direct connection between two computing devices, a direct connection between components of a system and/or computing device, and any combinations thereof. A network, such as network 650, may employ a wired and/or a wireless mode of communication. In general, any network topology may be used. Information (e.g., data, software 625, etc.) may be communicated to and/or from computer system 600 via network interface device 645.

Computer system 600 may further include a video display adapter 660 for communicating a displayable image to a display device, such as display device 665. Examples of a display device include, but are not limited to, a liquid crystal display (LCD), a cathode ray tube (CRT), a plasma display, and any combinations thereof. In addition to a display device, a network interface, and memory elements, a computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof. Query results as described herein may be presented via any of the output capable elements of computer 600 including, but not limited to, video display adapter 660 and/or one or more other peripheral output devices.

In one exemplary aspect of the implementations and embodiments described herein, clumping of constraints based on the same partition organization parameter value allows subqueries to be evaluated fully against a single partition. In another exemplary aspect of the implementations and embodiments described herein, the number of joins between partitions may be reduced. In yet another exemplary aspect of the implementations and embodiments described herein, the volume of data transferred between partitions may be reduced. In still another exemplary aspect of the implementations and embodiments described herein, clumped subqueries may be evaluated in parallel with each other on different partitions.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A method of optimizing query compilation, the method comprising:
receiving one or more constraints of a query;
identifying contiguous constraints having the same partition organization parameter value;
clumping the contiguous constraints by partition organization parameter;
organizing each clumping of constraints into a subquery;
compiling each subquery; and
evaluating each subquery against a partition of a graph, the partition having data records for the corresponding partition organization parameter value.
